(19) United States
(12) Patent Application Publication
(10) Pub. No.: US 2006/0193145 A1
(43) Pub. Date: Aug. 31, 2006

(54) Vehicle headlamp

(75) Inventors: Karsten Eichhorn, Wadersloh (DE); Christian Luder, Bielefeld (DE); Susanne Hagedom, Lippstadt (DE); Martin Wuller, Warendorf (DE)

Correspondence Address: HUSCH & EPPENBERGER, LLC, 190 CARONDELET PLAZA, SUITE 600, ST. LOUIS, MO, 63105-3441, US

(73) Assignee: Hella KG Hueck & Co., Lippstadt (DE)

(21) Appl. No.: 10/551,487

(22) PCT Filed: Apr. 3, 2004
(86) PCT No.: PCT/EP04/03565

§ 371 Date: Sep. 29, 2005

(30) Foreign Application Priority Data
Apr. 3, 2003 (DE) 10315131.1

(51) Int. Cl. F21V 21/00

(52) U.S. Cl. 362/545

(57) ABSTRACT

A headlamp for vehicle has at least one planar luminous panel of luminous-element chips, and an optical element arranged in the beam path of the light beam emitted by the luminous panel. The luminous-element chips (4) of the luminous panel (3, 21, 31) are arranged in a common recess (5). The recess (5) is on the side facing the direction of the light emission. The headlamp has an edge in spatial arrangement to the luminous-element chips such (4) that a predetermined luminance gradient (G, G′, G″) in a light distribution (L) of the headlamp is formed in the region of the edges (9, 25, 32).

### CROSS-REFERENCE TO RELATED APPLICATIONS

This applications claims the benefit of PCT/EP 2004/003565, filed Apr. 3, 2004 and claims priority of German Application No. 103 15 131.1 filed on Apr. 3, 2003

### BACKGROUND OF THE INVENTION

1. Field of the Invention

The invention concerns a headlamp for vehicles with at least one planar luminous panel having a plurality of luminous-element chips, and with an optical element arranged in the beam path of the light beam emitted by the luminous panel.

2. Related Art

From DE 100 09 782 A1 is known a headlamp for vehicles in which a plurality of luminous-element chips are arranged in the form of a matrix. To produce different light functions, a group of different luminous-element chips can be activated, so that a predetermined luminance distribution can be produced in conjunction with an optical element mounted in front of the luminous panel.

Also from EP 1 270 324 A2 is known a headlamp for vehicles with a plurality of luminous-element chips, different groups of luminous-element chips being activatable to produce different light functions. The plurality of luminous-element chips form a planar luminous panel which emits a light beam in the direction of light emission to an optical element designed as a converging lens. The optical element collects the light beam emitted by the luminous panel according to a predetermined luminance distribution.

With the known headlamps, the planar luminous panel is formed by a two-dimensional array in which the luminous-element chips are densely packed and regularly assembled.

### SUMMARY OF THE INVENTION

It is the object of the present invention to develop a headlamp for vehicles in such a way that firstly a space-saving and compact structure is ensured and secondly the effectiveness of the headlamp is increased.

To achieve this object, the invention in combination with the introductory part of patent claim 1 is characterised in that the luminous-element chips of the luminous panel are arranged in a common recess and in that the recess on one side facing in the direction of light emission has an edge in such a way in a spatial arrangement to the luminous-element chips that a predetermined luminance gradient in a luminance distribution of the headlamp is formed in the region of the edges.

Advantageously, due to a selected edge of a luminous panel which is spatially in relationship to the luminous-element chips, the invention allows the formation of a relatively sharp light/dark boundary in the luminance distribution of the headlamp. The basic concept of the invention is to position a plurality of luminous-element chips in a spatial arrangement to an edge, so that a steep luminance gradient is formed in a luminance distribution along a line perpendicularly to the edge. By this means, in combination with the optical element mounted in front, a light/dark boundary of substantially improved design can be produced.

According to a preferred embodiment of the invention, the recess is trough-shaped for receiving the luminous-element chips, the edge being formed by the free end of an edge wall extending from a base side of the luminous panel. Advantageously, the recess can serve as a common housing for the plurality of luminous-element chips, wherein, due to selective relative spatial arrangement of some of the luminous-element chips to the edge, the formation of a sharp light/dark boundary is promoted substantially.

According to a development of the invention, the shape of the recess or the shape of the edge or edge wall of the recess is adapted to the luminance distribution to be produced. The shape of the recess or edge thus marks the luminance distribution, wherein for example by means of an edge provided with a break an asymmetrical luminance distribution can be produced.

According to a development of the invention, the recess is filled with a light-converting luminescent material, so that the light emitted by the luminous-element chips is converted to white light. Advantageously, the luminescent material is integrated in a cast material, so that in a space-saving manner firstly light conversion and secondly mechanical protective covering of the luminous-element chips are provided.

According to a development of the invention, a bottom surface of the recess is reflectively coated, so that there is an increase in lighting efficiency and furthermore the steepness of the luminance gradients can be influenced in the desired manner.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

Practical examples of the invention are described in more detail below with the aid of the drawings. They show:

FIG. 1a a schematic perspective view of a first embodiment of the invention,

FIG. 1b a light distribution of the headlamp as in FIG. 1a,

FIG. 2 a perspective drawing of a luminous plate of the headlamp having the plurality of luminous-element chips as in FIG. 1a,

FIG. 3 a section along the line III-III as in FIG. 2,

FIG. 4a a top view of a luminous panel of the headlamp as in FIG. 1a or of a luminous plate of the headlamp as in FIG. 2,

FIG. 4b a luminance distribution of the luminous panel as in FIG. 4a along the lines a and b,

FIG. 5a a schematic perspective view of a headlamp according to a second embodiment,

FIG. 5b a light distribution of the headlamp as in FIG. 5a,

FIG. 6a a top view of a luminous panel of the headlamp as in FIG. 5a,

FIG. 6b a luminance distribution of the luminous panel as in FIG. 6a along the lines a and b,

FIG. 7a a schematic perspective view of a headlamp according to a third embodiment,

FIG. 7b a light distribution of the luminous panel as in FIG. 7a along the lines a and b,

FIG. 8a a top view of a luminous panel of the headlamp as in FIG. 7a, and

FIG. 8b a luminance distribution of the luminous panel as in FIG. 8a along the lines a and b.

### DETAILED DESCRIPTION OF THE PREFERRED EMBODIMENTS

The following description of the preferred embodiment(s) is merely exemplary in nature and is in no way intended to limit the invention, its application, or uses.

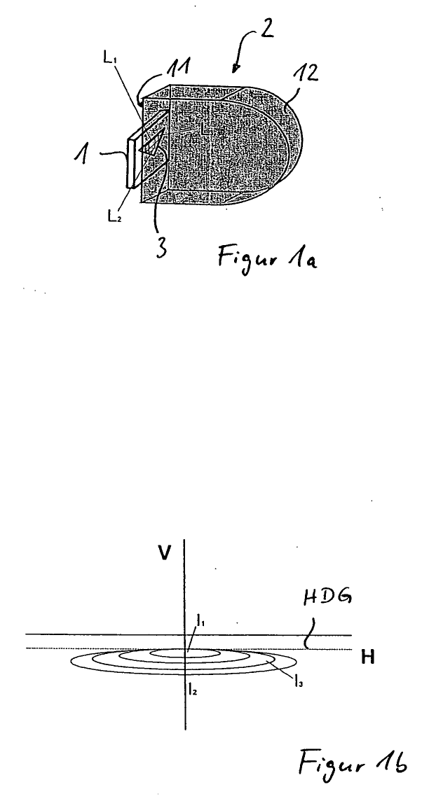

A headlamp for vehicles according to a first embodiment as in FIG. 1a to FIG. 4b essentially consists of a luminous plate 1 and an optical element 2, which are fixed in a conventional manner in a headlamp housing, not shown. Alternatively, several luminous plates 1 which in combination produce a common light distribution may be provided.

The luminous plate 1 has a triangular luminous panel 3 in which are arranged a plurality of luminous-element chips 4.

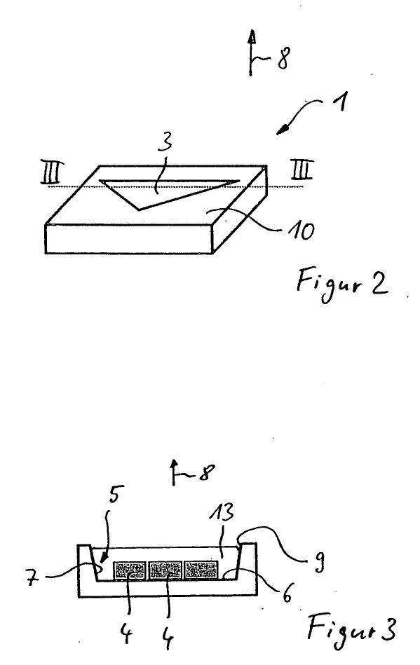

As can be seen better from FIGS. 2 and 3, the luminous plate 1 has a recess 5 to the bottom surface 6 of which are attached the luminous-element chips 4. The recess 5 is designed as a trough, wherein upright edge walls 7 extend from the bottom side 6 at the edge in the direction of a direction of light emission 8 of the luminous panel 3. The free end of the edge wall 7 forms an edge 9 from which a front side 10 of the luminous plate 1, which front side 10 defines the recess 5, extends in a plane. The luminous plate 1 is cuboid.

The bottom side 6 may be reflectively coated, so that the luminance distribution is improved.

As is clear from FIG. 1a, the luminous plate 1 abuts by the front side 10 against a light input surface 11 of the optical element 2.

The optical element 2 serves as a light-conducting element and has a convex-shaped light exit surface 12 in the direction of light emission 8.

In FIG. 1b is shown the light distribution of this headlamp, different regions L₁, L₂, L₃ of the luminous panel 3 being responsible for different intensities I₁, I₂, I₃ of luminance distribution.

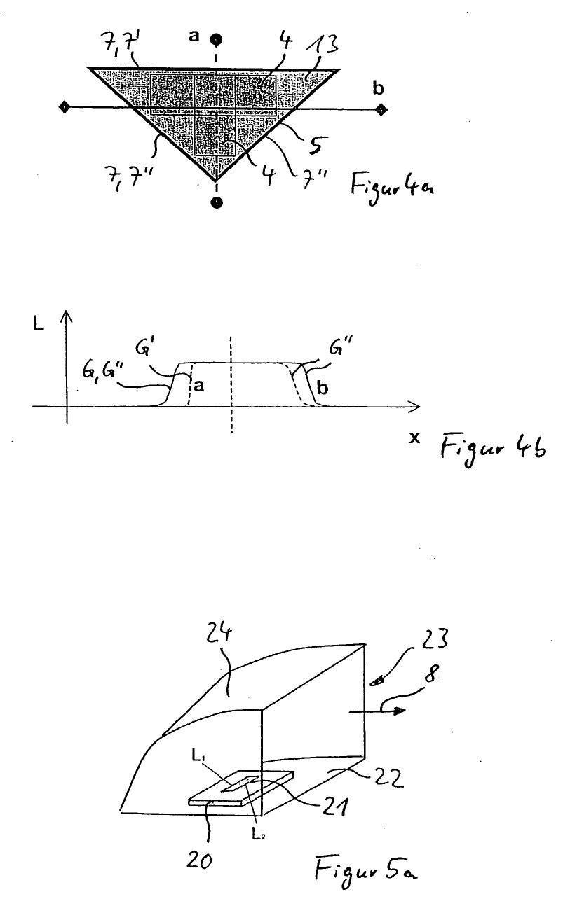

As is particularly clear from FIGS. 4a and 4b, the luminous-element chips 4 are also positioned in a triangular arrangement in the recess 5 which is triangular in a top view, the distance from the luminous-element chips 4 facing towards a preferred edge wall 7′ of the triangular recess 5, to the edge wall 7′, being small. Preferably, these luminous-element chips 4 abut directly against the corresponding edge wall 7′. The gap between the luminous-element chips 4 and the other edge walls 7″ is filled by a filler with a light-collecting or light-converting auxiliary material. Preferably, the luminous-element chips 4 are completely covered with a cast material 13 which extends from the bottom side 6 to a plane in which the front side 10 extends. The cast material 13 has in particular a light-converting luminescent material by means of which the blue light emitted by the luminous-element chips 4 is converted to white light by additive colour mixing.

The luminous-element chips can be designed as volume spots having a size of 1 mm². The luminous-element chips 4 are constructed so as to be able to emit light in a lateral direction, that is, perpendicularly to the main direction of emission. The luminous-element chips 4 are preferably designed as light-emitting diode chips (LED chips).

As is clear from the luminance distribution L along the lines a and b as in FIG. 4b, the lateral distance from the luminous-element chips 4 to the respective edge walls 7, 7′, 7″ has a substantial effect on the shape of a luminance gradient G. A gradient G′ in the region of the preferred edge wall 7′ is relatively large, that is, the luminance distribution has a steep ascent in this region, so that in combination with the optical element 2 a relatively sharp light/dark boundary LDB can be obtained. The other transitions in the regions of the edge wall 7″ have a smaller luminance gradient G″.

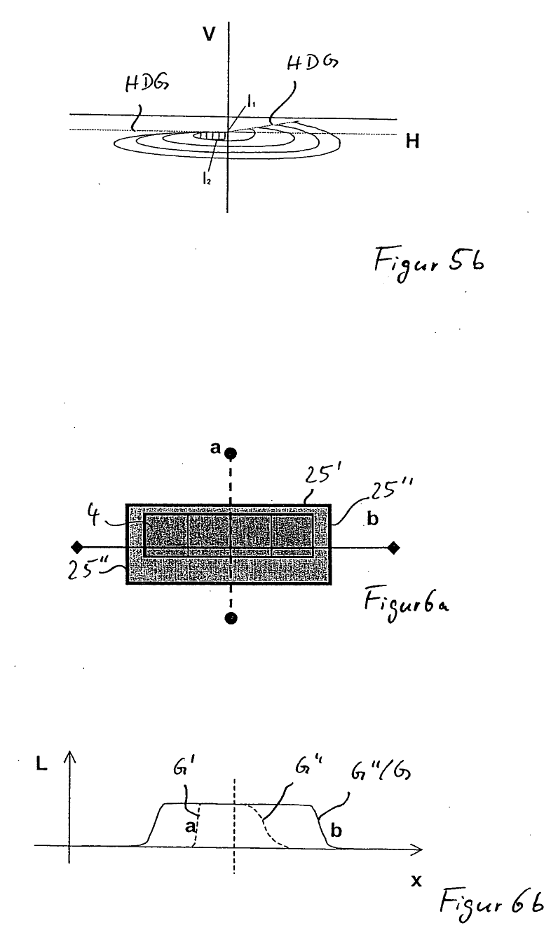

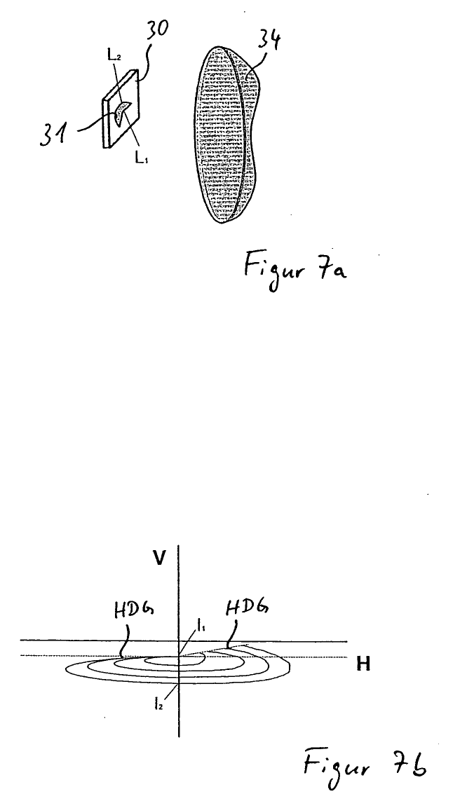

According to a second embodiment of a headlamp as in FIGS. 5a to 6b, a luminous plate 20 with a rectangular luminous panel 21 is provided. The luminous plate 20 rests in planar fashion on a bottom surface 22 of an optical element 23. The optical element 23 has an arcuate reflective surface 24 which is formed after the fashion of a hammer-forged surface, so that a luminance distribution as in FIG. 5b is produced.

As can be seen from FIGS. 6a and 6b, the luminous-element chips 4 lie relatively close to a preferred edge wall 25′, so that a relatively large luminance gradient G′ is obtainable. The latter allows the relatively sharp light/dark boundary LDB, the asymmetrical shape of the light/dark boundary LDB (15° ascent) being produced by the bulging shape of the reflective surface 24 of the optical element 23.

In FIG. 5b is shown the intensity peak 12 which is determined in width and shape by the four luminous-element chips 4. The intensity I₁ at the light/dark boundary LDB is determined by the strong decline in luminance L₁ in the region of the preferred edge wall 25′. The distance between the luminous-element chips 4 and the other edge walls 25″ is greater, so that the corresponding luminance gradients G″ are made flatter. The distance between the luminous-element chips 4 and the edge walls 25 is a measure of the steepness of the decrease in luminance or the magnitude of the luminance gradient G.

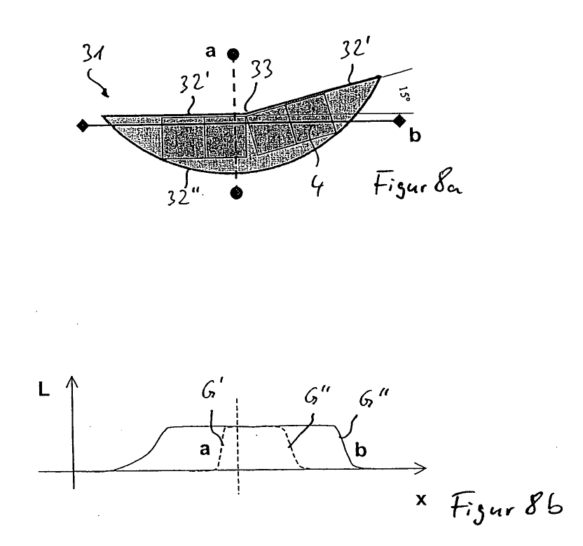

According to a third embodiment as in FIGS. 7a to 8b, a luminous plate 30 with an asymmetrically constructed luminous-panel/recess 31 is provided. The luminous panel and the recess 31 are defined by edge walls 32 in accordance with the preceding examples, a preferred edge wall 32′ having a break 33 from which a section of the edge wall 32′ extends further at an angle of 50°. The luminous-element chips 4 abut directly by their side walls against the two sections of the edge wall 32′ separated by the break 33, so that a large luminance gradient G′ is formed to form the light/dark boundary LDB.

As can be seen from FIGS. 7a and 7b, an optical element 34 which is designed as a lens and arranged at a distance from the luminous plate 30 is provided. A lower region L₁ of the luminous panel which runs along the preferred edge wall 32′ corresponds to an intensity range I₁ of light distribution, at the edge of which runs the light/dark boundary LDB. An upper region L₂ of the luminous panel is projected in a lower intensity range I₂ of light distribution projected on a measuring screen arranged at a standardised distance. The luminous plate 30 is preferably arranged in a focal plane of the lens 34.

A common feature of the above practical examples is that most of the recess is filled by the luminous-element chips 4, but for the formation of a light/dark boundary LDB the distance from groups of luminous-element chips 4 to the edge is relatively small or zero. The different geometries of the luminous panels can be used individually or in combination to generate different light distributions, in particular in each case for the formation of basic light, asymmetrical light or other light configurations. The headlamp formed in this way can, for example, be used to produce a dipped beam, main beam, motorway beam and/or cornering beam function.

As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

1. Headlamp for vehicles comprising:
at least one planar luminous panel having a plurality of luminous-element chips;
an optical element arranged in the beam path of the light beam emitted by the luminous panel;
the luminous-element chips (4) of the luminous panel (3, 21, 31) being arranged in a common recess;
the recess (5) being on one side facing in the direction of light emission (8);
an edge (9, 25, 32), the edge being in a spatial arrangement to the luminous-element chips (4) such that a predetermined luminance gradient (G, G′, G″) in a light distribution (L) of the headlamp is formed in the region of the edges (9, 25, 32).

2. Headlamp according to claim 1, wherein the recess (5) is trough-shaped with an edge wall (7, 7′, 7″) which runs perpendicularly to the direction of light emission (8) of the luminous panel (3) and stands up from a bottom side (6) of the recess (5) and on whose side facing away from the bottom side (6) runs the edge (9).

3. Headlamp according to claim 1, wherein the edge (9) runs peripherally in a plane which is oriented perpendicularly to the main direction of emission of the luminous panel (3).

4. Headlamp according to claim 1 wherein the shape of the edge wall (7, 7′) and/or edge (9) is such that, in combination with the optical element (2, 23, 34) mounted in front, a predetermined luminance distribution is produced.

5. Headlamp according to claim 1, wherein the edge wall (7, 7′) and/or the edge (9) of the recess (5) has a rectangular or triangular or circle segment shape in a top view, and in that the edge (32, 32′) has a break (33) for forming an asymmetrical light/dark boundary (LDB).

6. Headlamp according to claim 1, wherein several light-emitting diode chips (4) are arranged directly adjoining at least the edge wall (7, 7′) comprising the edge (9) which produces the light/dark boundary (LDB).

7. Headlamp according to claim 1, wherein the recess (5) is filled with a light-converting luminescent material, such that the light emitted by the luminous-element chips (4) is converted to white light.

8. Headlamp according to claim 1, wherein the light-converting luminescent material is integrated in a cast material which covers the recess (5).

9. Headlamp according to claim 1, wherein the bottom side (6) of the recess (5) is reflectively coated.

10. Headlamp according to claim 1, wherein the luminous panel (3) is integrated in a luminous plate (1), the recess (5) being set in a front side (10) of the luminous plate (1) running perpendicularly to the direction of light emission (8).
